(19) United States
(12) Patent Application Publication
(10) Pub. No.: US 2025/0378407 A1
(43) Pub. Date: Dec. 11, 2025

(54) TECHNIQUES FOR MANAGING DATA FOR A CLIENT IN A COMPUTER NETWORK

(71) Applicant: Zoura, Inc., Redwood City, CA (US)

(72) Inventors: Param VISWANATHAN, San Jose, CA (US); Cheng ZOU, Cupertino, CA (US)

(21) Appl. No.: 18/736,378

(22) Filed: Jun. 6, 2024

Related U.S. Application Data
(63) Continuation of application No. 13/687,650, filed on Nov. 28, 2012.
(60) Provisional application No. 61/564,777, filed on Nov. 29, 2011.

(51) Int. Cl. G06Q 10/0637; G06Q 10/0639

(52) U.S. Cl. CPC G06Q 10/0637; G06Q 10/0639

(57) ABSTRACT

A method of managing data for a client in a computer network, wherein the client has an associated product/service account maintained by a client data management system. The product/service account specifies at least one product/service to be assessed according to a defined plan having assessment data objects which in turn have attributes such as an assessment type, a trigger condition, a unit of measurement, and a cost per unit of measurement. The method includes defining an assessment data segment associated with an assessment data object, the assessment data segment being a time-based application of the assessment data object, and includes attributes such as its associated assessment data object and the assessment data object's attributes, an effective start time, a quantity of units, and a cost. The client's use of the product/service is monitored and assessment events are generated according to the defined assessment data objects and segments.

### BACKGROUND

Many of today's products and services are implemented with an array of components, support services, utilities and computing resources, and each of the components has associated costs. As a convenience to their clients, vendors typically attempt to provide a wide variety of assessment options for clients using their products and services, while also simplify the assessment options into a single assessment option or a simple recurring assessment option. However, the complex, changing nature of the modern business environment can stress such attempts at assessment simplification. For example, different client usage patterns can mean a single assessment option may not be appropriate for particular clients.

As assessment options become more complex, new problems may arise including problems associated with resource utilization, client data access configurations, client data management, and client data status presentation. Conventional attempts to address such problems are flawed. For example, some conventional systems are inefficient and/or ineffective. Some conventional systems are insufficiently flexible. Some conventional systems are difficult to configure and/or administer. Some conventional systems fail to clearly communicate client data status to clients; for example, such systems may generate client data reports that result in a relatively high number of client queries with respect to client data details and/or that are not in accordance with client expectations.

Embodiments of the present disclosure are directed toward solving these and other problems individually and collectively.

### SUMMARY

The terms “disclosure,” “the disclosure,” “this disclosure” and “the present disclosure” used in this patent are intended to refer broadly to all of the subject matter of this patent and the patent claims below. Statements containing these terms should be understood not to limit the subject matter described herein or to limit the meaning or scope of the patent claims below. Embodiments of the present disclosure covered by this patent are defined by the claims below, not this summary. This summary is a high-level overview of various aspects of the present disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the present disclosure are directed to techniques for managing data for a client in a computer network, wherein the client has an associated product/service account maintained by a client data management system, wherein the product/service account specifies at least one product/service to be assessed according to a defined plan, wherein the defined plan comprises at least one assessment data object having attributes including a trigger condition, a unit of measurement, and a cost per unit of measurement. In at least one embodiment, the techniques may be realized as a method for managing data for a client in a computer network, wherein the client has an associated product/service account maintained by a client data management system, wherein the method comprises defining at least one assessment data segment associated with at least one assessment data object, wherein the at least one assessment data segment is a time-based application of the at least one assessment data object and has attributes including attributes of the associated at least one assessment data object, a quantity of units of measurement, and a cost. The method also comprises monitoring the client's use of the product/service according to the units of measurement, generating assessment events in accordance with the at least one assessment data object and the at least one defined assessment data segment, wherein each assessment event represents an assessment of an aspect of the product/service account, and periodically aggregating the assessment events into a single aggregate assessment for notifying the client of a current single aggregate assessment.

Other objects and advantages of the present disclosure will be apparent to one of ordinary skill in the art upon review of the detailed description of the present disclosure and the included figures.

### BRIEF DESCRIPTION OF THE DRAWINGS

Various embodiments in accordance with the present disclosure will be described with reference to the drawings, in which:

FIG. 1 is a schematic diagram depicting aspects of an example computing environment in accordance with at least one embodiment of the present disclosure;

FIG. 2 is a schematic, stack model diagram depicting aspects of an example client data management service in accordance with at least one embodiment of the present disclosure;

FIG. 3 is a schematic diagram depicting aspects of a client data management model in accordance with at least one embodiment of the present disclosure;

FIG. 4 is a schematic diagram depicting at least some aspects of the functionality of an assessment engine in conjunction with the client data management model depicted in FIG. 3, in accordance with at least one embodiment of the present disclosure;

FIG. 5 is a flow chart depicting at least some aspects of the functionality depicted in FIG. 4 in accordance with at least one embodiment of the present disclosure;

FIG. 6 is a flow chart depicting at least some aspects of the functionality of the present disclosure; and

FIG. 7 is a schematic diagram depicting aspects of a non-limiting, exemplary computing architecture suitable for implementing at least some embodiments of the present disclosure.

### DETAILED DESCRIPTION

Various exemplary embodiments of the present client data management system (CDMS) are described herein with the specificity necessary to meet statutory requirements. However, this description is intended only to aid a person having ordinary skill in the relevant art in appreciating and understanding the subject matter defined by the claims which follow. Specifically, such a person will understand and appreciate the subject matter defined by the claims to be inclusive of broader, narrower, alternative and/or additional embodiments, which may, for example, include different and/or additional elements or steps than those included in the described exemplary embodiments. Such a person will further understand that the scope of the claims includes any embodiment of the claimed subject matter implemented by, or used in conjunction with, technologies other than those explicitly described herein, whether existing at the time of present disclosure or later developed. This description should not be interpreted as implying any particular priority, order, or arrangement among or between various elements or steps of the described embodiments, except when such priority, order or arrangement is explicitly defined by the claims.

Various aspects of at least one exemplary embodiment of the present CDMS are described below. The present CDMS is generally directed at addressing problems associated with resource utilization, client product/service configurations, client account management, and client account status presentation created by complex assessment models, particularly those associated with client product/service term assessments.

Embodiments of the present CDMS may address the aforementioned problems by providing an efficient, effective and flexible system and method of client data management. A user of such an embodiment may specify products and/or services (collectively referenced herein as “products”), for example, with a web-based user interface, and associate same with assessments including one-time assessments, recurring assessments, and usage-based assessments. In accordance with at least one embodiment of the CDMS, such specification is flexible enough to support a wide variety of product/service term assessment options including for time-based products/services such as telecommunication system use, provision of and access to remote computing resources, and content delivery products having assessment amounts determined based on one or more characteristics of the content and/or timing of delivery (e.g., assess upon release, assess after an elapsed interval of time, etc.). Client accounts may be maintained and associated with client product/service terms referencing one or more products and services. Client product/service terms may be amended over time, and a history of such amendments may be maintained. Assessment data segments, corresponding to assessments incurred by clients and aligned to suitable time intervals such as time intervals associated with time boundaries (e.g., beginnings and endings of days, weeks, months, quarters, calendar years, financial years), may be generated in accordance with client product/service terms. Assessment events may be generated in accordance with assessment data segments and formatted for presentation to clients.

Aspects of at least one exemplary embodiment of the inventive CDMS contribute to an ability to support a wide variety of product/service term assessment options by providing (1) flexibility in specifying assessments, (2) the ability to collect assessments in conjunction with defined plans, and (3) generating assessment data events based on assessment data segments and assessment data objects. Examples of such flexible assessment options include assessments specified in accordance with a commit assessment model and assessments specified in accordance with a discount assessment model. Additionally, a combination of a discount and commit assessment model can be specified.

At least some embodiments of the present CDMS may be used to model “pre-assessed” products or services according to a commit and/or discount assessment model. For example, a user may offer products/services according to product/service term based assessments as well as offer pre-assessed products/services, e.g. a mobile phone service provider may offer phone service based on monthly service terms or based on a client's advance purchase of “minutes” of usage on the provider's network. For some accounting and/or reporting purposes, such a user may wish to be able to model the “pre-assessed” product/service assessments in the same manner as its product/service term based assessments, for example, in order to aggregate total assessments or make direct assessment comparisons.

With respect to assessments specified in accordance with a commit assessment model, for example, assessments may be associated with a committed amount of resources made available by the user for potential use by a client per amount of time (e.g., 1200 units per year, 100 units per month, etc.). Resource utilization may be received and/or measured at regular intervals, or assessment periods, e.g. monthly. If aggregate usage exceeds the committed amount for a given time period, an overage assessment event may be generated. An optional smoothing may be applied with respect to aggregate usage determination. For example, aggregate resource utilization may be determined with respect to a “rolling window” of time with respect to a current measurement and/or assessment period. For example, a base assessment associated with a product/service term may be based on the usage of a particular number of units committed per month, while the same product/service term may have overage assessments based on the client's aggregate usage of units exceeding a predetermined limit over a preceding interval, e.g. 7 days or 28 days, regardless of whether the interval substantially corresponds to an assessment period. Overage assessment data events may be applied at a configurable time with respect to factors such as the actual occurrence of the overage and/or a current measurement and/or assessment period.

Types of discount assessment models that may be utilized with at least one embodiment of the present disclosure include “fixed amount” discount assessment models and “percentage” discount assessment models. Discounts may be applied at product, product/service term, and/or account levels. Discounts may be one-time, recurring and/or apply for a limited period of time. Discounts may be reversible, for example, application of a discount may be conditioned upon satisfaction of the terms specified by a contract. Discounts may be configured to apply only to “positive” statements and/or account balances. Alternatively, or in addition, “negative” account balances may be “rolled over” between statement periods. Discounts may be conditionally applied to all assessments or to assessments of a particular type. Tax assessments may be determined at a specified time with respect to the application of a discount (e.g., after the application of the discount). A determined discount amount may be capped with respect to various time intervals (e.g., statement period), and discounts may be conditional on the presence or absence of overage assessments.

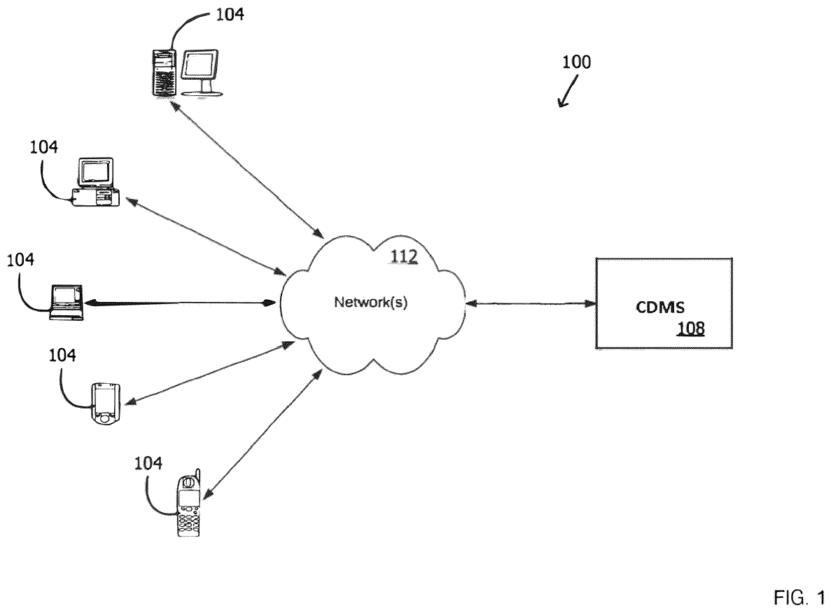

FIG. 1 depicts aspects of an example computing environment 100 in accordance with at least one embodiment of the present disclosure. A variety of clients (not shown) incorporating and/or incorporated into a variety of computing devices 104 may communicate with a client data management service 108 through one or more networks 112. For example, a client may incorporate and/or be incorporated into a client application implemented at least in part by one or more of the computing devices. Examples of suitable computing devices 104 include personal computers, server computers, desktop computers, laptop computers, notebook computers, personal digital assistants (PDAs), smart phones, cell phones, computers, tablets and consumer electronics incorporating one or more computing device components such as one or more processors. Examples of suitable networks 112 include networks including wired and wireless communication technologies and networks operating in accordance with any suitable networking and/or communication protocol.

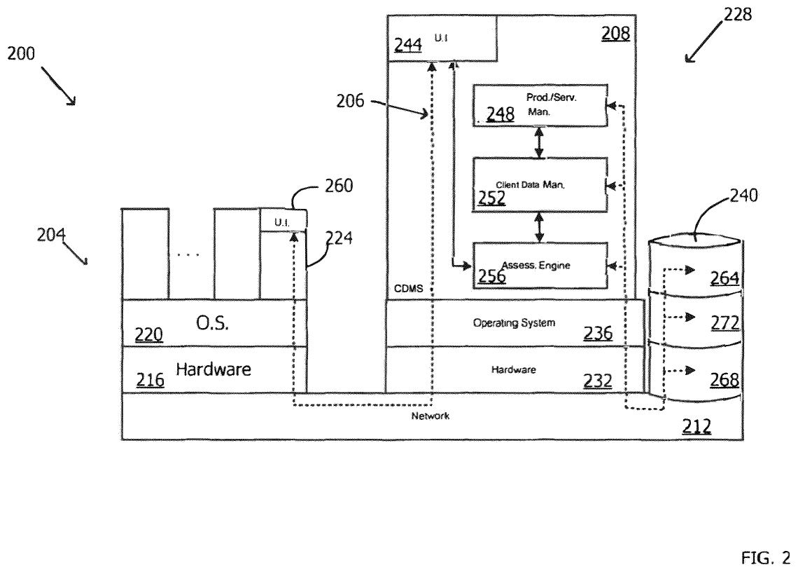

FIG. 2 depicts a conceptual “stack” model 200 of an exemplary embodiment of a client data management system (CDMS) hosted on an exemplary computing environment, as shown in FIG. 1. An exemplary computing device 204 is in data communication 206 with a client data management service 208 over a network 212. The computing device 204 may include hardware 216, an operating system 220, and a client application 224. The client data management service 208 may also be hosted on at least one computing device 228, such as a server, that may include hardware 232 and an operating system 236. Data related to the client data management system may be stored in at least one database 240, which may be hosted on a separate computing device (not shown) from the client data management service 208. The client data management service 208 may include one or more user interfaces 244, including one or more programmatic interfaces and/or one or more graphical user interfaces (GUIs), configured at least to enable access to functionality of the service 208. The client data management service 208 may include a product/service manager component 248 configured to at least enable establishment and maintenance of product and service specifications including, for example, associated rate plans and assessments. The client data management service 208 may include a client data manager component 252 configured at least to enable establishment and maintenance of client data and associated products and services. The client data management service 208 may further include an assessment engine component 256 configured to at least periodically generate assessment events in accordance with active products and services. The assessment engine component 256 may be further configured to generate client data reports for delivery to clients based at least in part on the generated assessment events. Such reports may be presented to clients and accessible in a variety of formats, including a printed format and an electronic format, for example, through the graphical user interface 244 of the client data management service 208 or a user interface 260 of the client application 224. The database 240 may be divided between data related to offered products/services 264, client data management details 268, including client data reports, and client-related products and services 272.

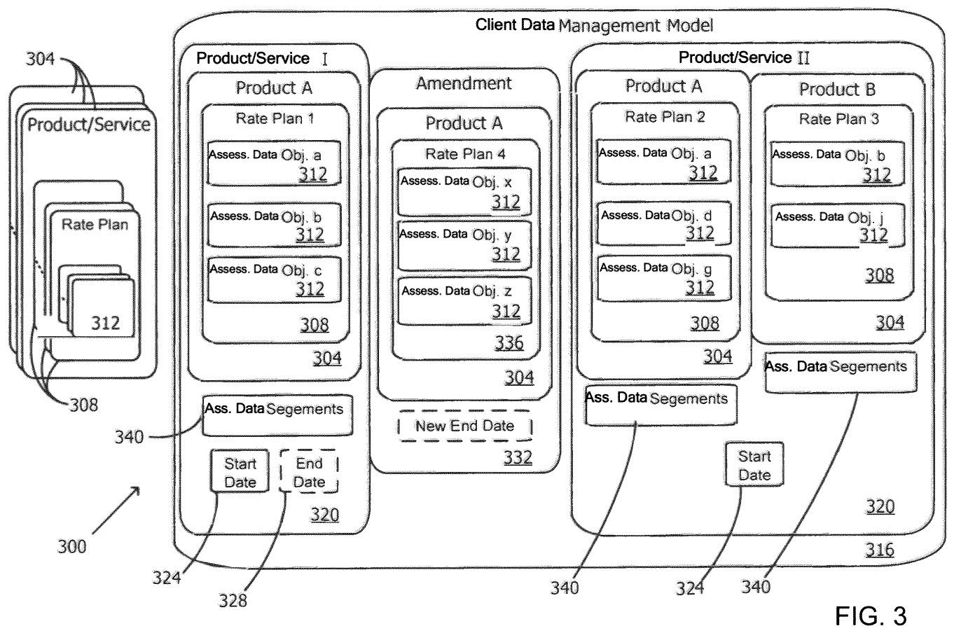

FIG. 3 depicts aspects of an exemplary client data management model 300 used to manage client product/service term assessment data in accordance with at least one embodiment of the CDMS. Each offered product (or service) 304 may be associated with one or more rate plans 308. A rate plan may include one or more types of associated assessment data objects 312, including one-time assessment data objects, recurring assessment data objects, usage assessment data objects, overage assessment data objects and discount assessment data objects, among other exemplary assessment data objects. A client account 316 may be associated with one or more products/services 320. A product/service 320 may define one or more of the specified products/services 304 and an associated rate plan 308 for each of the products/services 304.

Products/services may have a start date 324 and an end date 328, but in at least one embodiment a product/service need not have an end date. Amendments 332 may modify an existing product/service 320, for example, to update an end date 328, to modify a set of associated products/services (not shown), and/or to modify a selected rate plans 336 associated with the set of associated products/services. Products/services 320 may be associated with a set of contract terms and conditions, and amendments 332 may correspond to contract amendments. Assessment data objects 312 may trigger the generation of assessments upon the occurrence of an event, such as a contract becoming effective and a product or service becoming active, an overage being detected, an assessment period ending (or beginning), or a discount becoming effective (or expiring). The client data management model 300 could be implemented as a management model such as described in U.S. patent application Ser. No. 13/687,650, which is incorporated by reference herein in its entirety.

Assessment data objects 312 may have attributes including an assessment data object identifier (e.g., a unique identifier with respect to assessment data objects), an assessment data object name, an assessment data object description (e.g., a human-readable description), an assessment data object type (e.g., one-time, recurring, usage-based, discount, etc.), an assessment data object trigger condition or conditions, an assessment data object unit of measurement, an assessment data object creation date, an assessment data object “created by” identifier (e.g., referencing an authorized user of the client data management service), an assessment data object last modified timestamp (e.g., time and/or date), and an assessment data object “modified by” identifier. However, assessment data objects 312 are preferably not associated with a particular date or dates.

Rather, an assessment data object 312 may be used in conjunction with other characteristics of a given product/service to derive assessment data segments 340 for that product/service, with the assessment data segments corresponding to sub-elements of an assessment data object that may track changes to an assessment data object 312 (and hence to an assessment or assessments levied) over each of a series of time intervals. For example, multiple assessment data segments 340 may be created with respect to a single recurring assessment data object 312, for example, in response to a change in an associated assessment data object at a certain time or during a certain time interval, such as the expiration of a discount, modeled on an “introductory period” for a product/service. As used herein, unless clearly contradicted by context, the terms “assessment,” “assessment data object,” and “assessment data segment” refer to data objects that provide information for generating “assessment events.” Further, in some embodiments, a set or sequence of such assessment events may be used to determine assessments to be applied to a client account, and as the basis for generating a client data report.

Assessment data segments 340 may have attributes including an assessment data segment identifier (e.g., a unique identifier with respect to assessment data segments), a reference to a generating assessment data object (and/or a copy of some or all of the generating assessment attributes), a quantity of units associated with the assessment data segment, a cost (e.g., a dollar amount) associated with the assessment data segment, effective start and end dates and/or times associated with the assessment data segment, “processed through” and “assessed through” dates and/or times associated with the assessment data segment, and indicators as to an assessment data segment's place in a series of assessment data segments (e.g., segment number, last segment indicator). As is described below, for each assessment data segment 340, the client data management engine may generate one or more assessment events that are applied to a client account and/or appear on a client data report. Thus, unlike assessment data objects 312, assessment data segments 340 may be associated with time intervals, for example based on the product/service start date, product/service end date, a product/service term assessment period, a period in which a discount or other form of incentive applies, etc. The combination of a product/service's rate plan, assessment model, assessment data objects, etc. and derived assessment data segments, collectively form an assessment specification for the product/service.

Client accounts may have a hierarchical structure. For example, some accounts may be “parent” accounts with respect to “child” accounts. Products/services may be associated with parent accounts and/or child accounts. Client data reports may be generated with respect to parent accounts and/or child accounts. Service and/or resource utilization may be associated with child accounts and reported (including aggregated and/or summarized) at a parent account level.

In accordance with at least one embodiment of the CDMS, conceptual separation of date-associated assessment data segments 340 from specified assessment data objects 312 associated with products/services contributes to client data management service flexibility. While previous attempts at providing a product/service-based client data management service required, for example, a user to explicitly define how and when various assessments should be incurred resulting in relatively complicated and non-fungible product/service definitions, in the case of the present CDMS, because the assessment data objects can be generally defined without being associated with specific dates or time periods, the CDMS allows a user to use, and reuse, a relatively limited set of assessment data objects to customize its product/service assessment options to meet particular client needs.

For each product/service, the assessment engine of the CDMS may generate assessment events in accordance with assessment data objects and assessment data segments associated with products/services. The assessment engine may appropriately pro-rate assessments when generating assessment events based on associated assessment data segment information in the context of a product/service, report, and/or time period (collectively “assessment time period”). As part of processing recurring assessments, the assessment engine may maintain independent “processed through” and “assessed through” dates and/or times associated with assessment events. Recurring assessments may be applied in advance so that, in accordance with at least one embodiment of the present disclosure, there is a need to keep track of starting points and ending points associated with assessment engine processing of recurring assessments. For example, suppose that an assessment event associated with a monthly recurring assessment is generated for the period Mar. 1, 2011 through Mar. 31, 2011. Then the “processed through” date for the recurring assessment may be set to Mar. 1, 2011 and the “assessed through” date may be set to Mar. 31, 2011. When a corresponding assessment event for the month of April is generated, the “processed through” and “assessed through” dates may be advanced to Apr. 1, 2011 and Apr. 30, 2011, respectively. As will be apparent to one of skill in the art, the differing “assessed through” date can have consequences for determining and/or forecasting performance and other statistics and/or metrics.

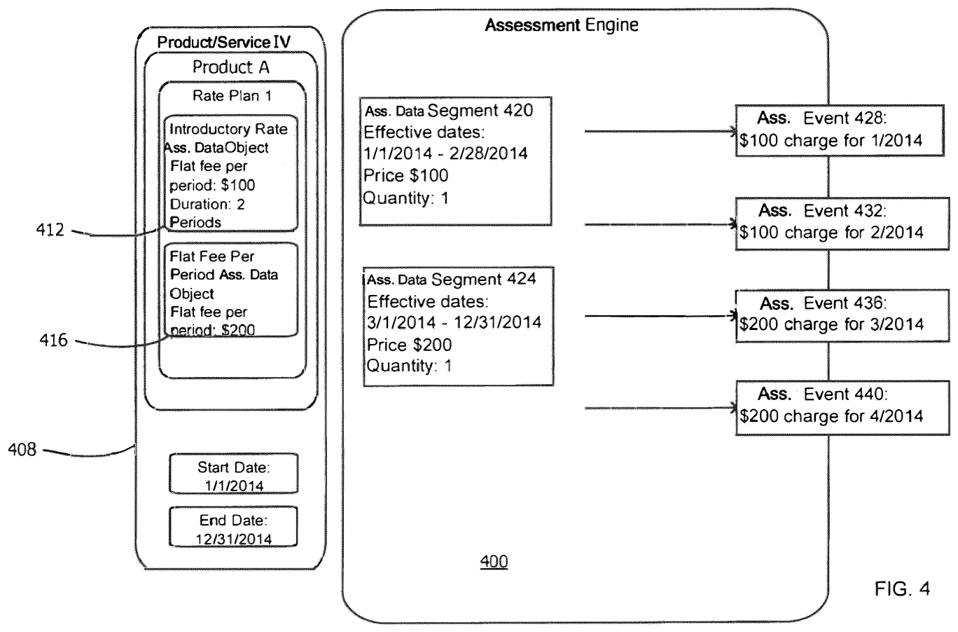

Referring to FIG. 4 by way of example, exemplary embodiments of the CDMS may include components, such as an assessment engine 400, similar to the assessment engine depicted in FIG. 2, which may generate assessment events in accordance with the client data management model shown in FIG. 3. Suppose that a product/service term 408 begins on Jan. 1, 2014 and is assessed at a flat-fee per month and provides for an introductory rate of $100 per month for the first two months, then increases to the standard monthly rate of $200 per month for the remainder of a one year term. The client data management model may include an introductory rate assessment data object 412 and a flat fee per period assessment data object 416. The assessment engine will derive two assessment data segments based on the product/service's assessment data objects and effective dates:
(1) Assessment Data Segment 420 with attributes: effective from Jan. 1, 2011 to Feb. 28, 2011, price $100, quantity 1; and
(2) Assessment Data Segment 424 with attributes: effective from Mar. 1, 2011 to Dec. 31, 2011, price $200, quantity 1.
   When the Assessment engine processes the product/service with a client data report through the date of Apr. 30, 2011, it produces the following assessment events based on the assessment data segment data and the assessment time period of 1 month:
(1) Assessment Event 428 with attributes: fee for Jan. 1, 2011 to Jan. 31, 2011, $100×1=$100;
(2) Assessment Event 432 with attributes: fee for Feb. 1, 2011 to Feb. 28, 2011, $100×1=$100.
(3) Assessment Event 436 with attributes: fee for Mar. 1, 2011 to Mar. 31, 2011, $200×1=$200; and
(4) Assessment Event 440 with attributes: fee for Apr. 1, 2011 to Apr. 30, 2011, $200×1=$200.
   Eventually, the assessment engine may produce 10 assessment events of $200 associated with Assessment Data Segment 424, one for each of the ten non-discounted months, March through December, in the 12 month assessment time period.

For a product/service term, the assessment engine generates assessment events based on a product/service's assessment specification(s). In one example, an assessment specification defines an assessment data object in accordance with a commit assessment model, or a combination of a commit and discount assessment models. Units of measurement (UOM) may be specified, as well as the number of units that are “included” with a base assessment amount. The number of “included” units may be associated with a time period. For example, the time period may be fixed, or may be a “rolling window” that includes the current assessment period. A “rolling window” may be specified in terms of a number of assessment periods that precedes and includes the current assessment period. An assessment event corresponding to a base assessment data object may be generated. The assessment data specification may also include an overage assessment data object—in the event the client's usage exceeds the number of “included” units (i.e., those the client is entitled to under the terms of a product/service agreement or contract) with respect to a particular time period, the assessment engine may generate additional assessment events based on the overage assessment data objects, that is those based on the amount the usage that exceeds the number of “included” units. For example, the overage assessment data object may define a specified assessment per unit of usage that exceeds the number of “included” units. There may be several assessment “tiers” (not shown) associated with various “included” unit amounts that are taken into account before overage assessment events are generated. Similarly, there may be one or more overage assessment data object definitions that can be used to determine overage assessments based on different tiers, amounts, or levels of overage usage.

The “rolling window” described above is a type of commit assessment model smoothing. Commit assessment models in accordance with at least one embodiment of the present disclosure may include any suitable type of overage smoothing. For example, as well as a “rolling window” and the utilization of other types of accounting windows (e.g., fixed windows of time and windows defined with respect to classes of time such as mornings, weekends and holidays), overage may be smoothed with respect to measured resource utilization trends or averages or other suitable statistical properties. Measured resource utilization may be filtered, for example to ignore utilization “spikes,” allowing a client to avoid overage assessments if their usage spikes in any one period.

Referring again to FIG. 4, the product/service term may provide for 500 units per month but calculates overage assessments based on a 3 month rolling window. If the client's aggregate monthly usage is: 700 units in January, 200 units in February, 800 units in March, 100 units in April, 700 units in May, and 300 units in June, then the client will have exceeded its monthly allotment by 200 units in January, 300 units in March, and 200 units in May. However, overage assessments will be calculated based on the aggregate usage over the two 3 month windows, January-March and April-June. In the January-March window, overage assessment events will be generated based on the client exceeding its three month aggregate usage allotment of 1500 units by a total of 200. In the April-June window, the client used only 1,100 units, 400 less than its allotment and no overage assessment events will be generated. Assessment events associated with overage may be generated as soon as the overage is detected (e.g., detected by the client data management service), or at a later time, for example, at the end of an assessment period or a smoothing period. At times, some portion of the “included” units may be unused (e.g., as determined based on measured resource utilization). Such unused resource units may be credited to a next smoothing period (e.g., effectively increasing the “included” units available) or may be cancelled. A “next” smoothing period for a “rolling window” may correspond to a movement of the window to include a next assessment period. For example, the movement may be quantized with respect to types of time period such as a day, a week or a month.

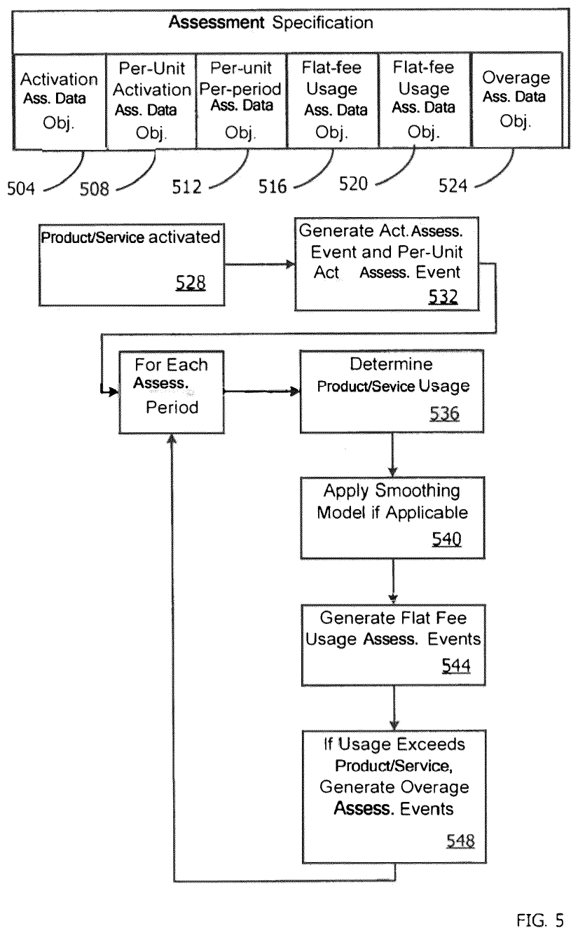

FIG. 5 depicts examples of assessment data objects that may be specified in an assessment specification in accordance with a commit assessment model. An activation assessment data object 504 may result in the generation of an assessment data event corresponding to a flat activation assessment at the outset of a product/service term. A per-unit activation assessment data object 508 may result in the generation of assessment events for each license activated under the product/service term. A per-unit-per-period assessment data object 512 may result in the generation of periodic assessment events for each license activated under the product/service term, and may be variable depending on the number of licenses activated. A flat-fee usage assessment data object 516 may result in the generation of periodic assessment events corresponding to usage of a particular feature of the product and/or service, and may be dependent on the amount of usage during an assessment period. An incremental service assessment data object 520 may result in the generation of periodic assessment events corresponding to a committed amount of usage of a product and/or service during an assessment period. Finally, an overage assessment data object 524 may result in the generation of overage assessment events corresponding to an amount of usage of a product and/or service that exceeds the committed amount specified by the incremental service assessment data object 520.

Still referring to FIG. 5, the present CDMS may generate assessment events based on the preceding example assessment specification. Upon activation 528, the activation assessment data object 504 may generate a one-time activation assessment event of $10,000, which may be waived upon purchase of more than 100 licenses and the per-unit activation assessment data object 508 may generate a one-time assessment event of $100 per activated license 532, which may be waived upon purchase of more than 100 licenses. For each assessment period, the assessment engine will determine an amount of product and/or service usage during the assessment period 536 and optionally apply any applicable smoothing techniques 540. The assessment engine will then generate monthly assessment events 544, based on the per-unit-per-period assessment data object 512 and flat-fee usage assessment data objects 516, 520. For example, the per-unit-per-period assessment data object 512 may generate assessment data events of $60 per license per month, and which may be increased to $65 per license per month for products/services with less than 10 licenses. The flat-fee usage assessment data object 516 may generate monthly assessment events for usage of an email tool, where the assessment event is $2000 in any month in which the tool processes less than 1 million emails and $3000 per month otherwise. Another type of flat-fee usage assessment data object 520 may generate monthly assessment events based on a $0.07 per minute assessment per the number of units of a service, e.g. minutes of access, used during the assessment period, and which may be dependent on the aggregated total usage in the assessment period, assessing $0.10 per minute if the service is used less than 50 minutes in a specified assessment period, otherwise $0.07/minute. If the usage during the assessment period exceeds a product/service term maximum, the assessment engine may also generate overage assessment events 548 in accordance with the overage assessment data object 524. The units of measurement may be any suitable measured utilization of resources including purchases, data processed, and service utilization time.

Exemplary embodiments of the present CDMS may also permit the assessment engine to generate assessment events based on an assessment specification in accordance with a discount assessment model. A discount assessment model may be a percentage discount with respect to an aggregate amount associated with assessment data segments in a current assessment period. Further examples of discount assessment models include a fixed amount discount. Discounts may be one-time or recurring and may apply to assessment data segments associated with one-time, recurring or usage-based assessments. Discounts may be applied with respect to a current assessment period (e.g., on a specified day of each assessment period), or with respect to any suitable condition or trigger event (e.g., contract acceptance, service activation). Discounts may apply for a specified number of assessment periods (e.g., first 6 months of a 12 month product/service term) and be limited by a specified account lifetime maximum (e.g., a maximum dollar amount). Discounts may be determined based on assessment events associated with particular assessments, specified assessment data types, products, rate plans, services, and/or accounts, including opt-in and opt-out specifications. Multiple discounts may apply to particular assessment events.

Further examples of assessments in accordance with an exemplary discount assessment model include: apply up to $100 discount per month to all the assessments of rate plan X, apply 20% discount for every assessment of product/service A in the account, and apply up to $1000 discount per month to all the assessments on the account. Discounts may be treated as a type of assessment and may generate discount assessment events including pro-rated assessment events as appropriate. The assessment engine may generate discount assessment events after non-discount assessment events and before determining tax assessments associated with assessment event amounts. Non-discount (“regular”) assessment events may be considered in a sorted order (e.g., sorted with respect to unique identifier and/or assessment event creation time) when determining discount assessment events. In accordance with at least one embodiment of the present disclosure, such ordered consideration enables discount application tracking and “reversal” when appropriate (e.g., responsive to product/service term amendment and/or cancellation).

Discount assessments, while being processed by the assessment engine, may maintain an open period and a discount balance. Assessment events generated in the open period may take advantage of the discount before its balance runs out. Product/service term cancellation may reverse the discount applied and return the amount to the discount balance. A left-over balance of a discount may be “rolled over” when the current assessment period closes, or not, as specified, or as determined by criteria set by a client or vendor. Discount assessment events may be inhibited if there are no corresponding regular assessments and/or if such assessment events would result in an account balance and/or a report balance less than zero.

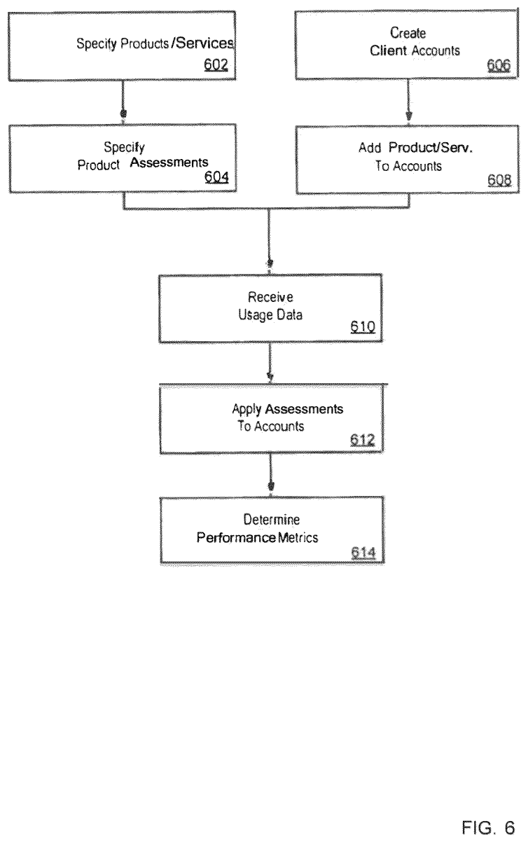

FIG. 6 depicts example steps in accordance with at least one embodiment of the present disclosure. At step 602, products/services may be specified, for example, with a graphical user interface of the client data management service. At step 604, product/service assessments may be specified, for example, as part of product/service specification. At step 606, client accounts may be created, for example, accounts for clients interested in using the products/services specified at step 602. At step 608, products/services may be associated with client accounts, for example, when an authorized user of a client account executes a service contract associated with a product/service. At step 610, resource utilization data may be received. For example, the client data management service may receive utilization data for resources associated with products/services (e.g., associated with a product/service identifier) from a vendor of a product/service referenced by the products/services. At step 612, assessments may be applied to accounts in accordance with the products/services, for example, the assessment engine may generate assessment events as described above. At step 614, one or more performance metrics may be determined based on the generated assessment events.

A product/service-based data model in accordance with at least one embodiment of the present disclosure may enable efficient and effective presentation of incurred assessments in accordance with client expectations. As described, such a data model includes a variety of assessment data objects for representing a variety of types of assessments, such as standard usage assessments, overage assessments, and/or discounts. Such assessment data objects are advantageously not time-based, allowing assessment data objects to be fungible between specific product/service instances. Instead, the data-model applies time-based variables to relatively generic assessment data objects to create assessment data segments specific to the particular product/service. In accordance with at least one embodiment of the present disclosure, such a data model further facilitates efficient and effective determination of performance metrics such as monthly recurring revenue (MRR), total contract value (TCV), total invoice amount and annual contract value. For example, such metrics may be determined based on assessment data segments, and rolled up through to the assessment, product/service and/or amendment, and account levels. Reliable determination of such metrics is not insignificant, since product vendor business decisions can depend on resultant values.

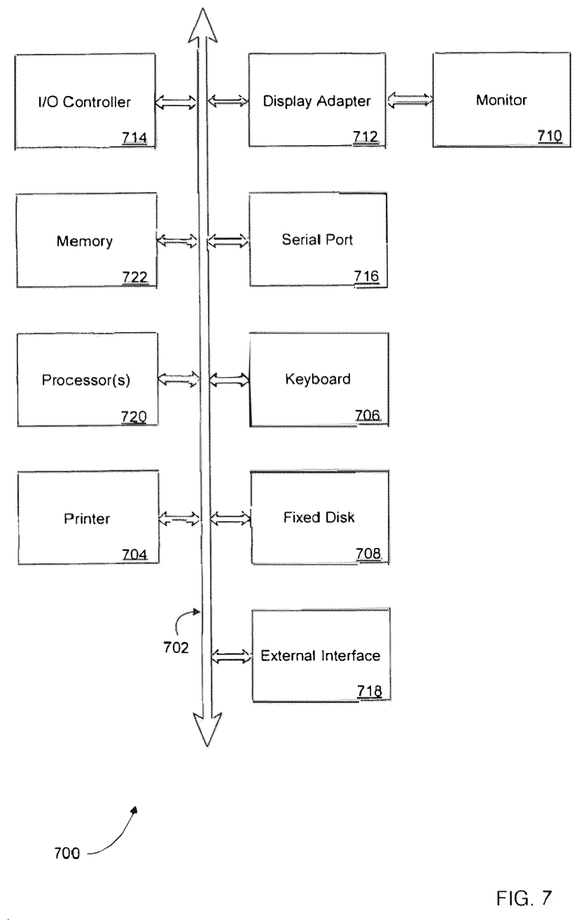

By way of a non-limiting example, FIG. 7 depicts aspects of elements that may be present in an exemplary computer architecture 700 which may be configured to implement at least some embodiments of the present methods and/or processes and/or systems. The architecture 700 includes subsystems interconnected via a system bus 702. The subsystems may include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices and/or systems not shown in FIG. 7 including a wide area network such as the Internet, a mouse input device, and/or a scanner. The interconnection via the system bus 702 allows one or more processors 720 to communicate with each subsystem and to control the execution of instructions that may be stored in a system memory 722 and/or the fixed disk 708, as well as the exchange of information between subsystems. The system memory 722 and/or the fixed disk 708 may embody a tangible computer-readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, C++, or Perl, using, for example, conventional or object-oriented techniques. The software code may be stored as a series of instructions, or commands on a computer readable medium, such as a random access memory (RAM) a read-only memory (ROM), a magnetic medium such as a hard-drive, a solid-state device such as a flash memory drive, or an optical medium such as a CD-ROM. Any such computer readable medium may reside on or within a single computational apparatus, and may be present on or within different computational apparatuses within a system or network.

Exemplary embodiments of the present CDMS have been described in detail above and in the accompanying figures for illustrative purposes. However, the scope of the present CDMS is defined by the claims below and is not limited to the embodiments described above or depicted in the figures. Embodiments differing from those described and shown herein, but still within the scope of the defined CDMS are envisioned by the inventors and will be apparent to persons having ordinary skill in the relevant art in view of this specification as a whole. The inventors intend for the defined CDMS to be practiced other than as explicitly described herein. Accordingly, the defined CDMS encompasses all modifications and equivalents of the subject matter as permitted by applicable law.

1. A computer-implemented method of managing data for plurality of users in a computer network, wherein each user has a plurality of clients, wherein each client of each user has a respective associated account maintained by a client data management system comprising a distributed system of a plurality of computers, the method comprising:
providing a user interface, communicatively coupled to and configured to operate in the client data management system, for providing user access to a client data manager and an assessment engine executing on the client data management system;
receiving, via the user interface from each user of the plurality of users, a plurality of plan definitions, each plan definition identifying a respective product or service associated with a respective user and defining corresponding plan information;
generating, by the client data manager of the client data management system, responsive to receiving a plan definition of a product or service of a particular user, a plurality of different time-independent assessment data objects for the plan definition, wherein each assessment data object comprises attributes including at least a trigger condition, a unit of measurement, and a cost per unit of measurement;
generating, by the client data manager of the client data management system, responsive to the generation of the plurality of different time-independent assessment data objects, a respective assessment data segment associated with each of the plurality of assessment data objects, wherein each assessment data segment defines an interval of time over which the associated assessment data object will be applied,
wherein each assessment data segment maintains a respective assessed-through cursor and a processed-through cursor, wherein the assessed-through cursor represents how far into the future assessments for the corresponding assessment data object are defined, and wherein the processed-through cursor represents how many assessment periods have already generated assessment events for the corresponding assessment data object;
generating, by the assessment engine of the client data management system, assessment events according to assessment data segments and one or more trigger conditions of the plurality of assessment data objects of the plan definition and, after generating each assessment event for an assessment data segment, updating the processed-through cursor of the assessment data segment;
before the processed-through cursor reaches the assessed-through cursor of an assessment data segment for a particular original assessment data object of the plan definition, receiving a change to the original assessment data object;
in response to receiving the change to the original assessment data object, generating a modified version of the original assessment data object for the plan and adding a new assessment data segment for the modified assessment data object, wherein the new assessment data segment covers a time period subsequent to assessment events generated from the original assessment data segment of the original assessment data object;
generating, by the assessment engine of the client data management system, additional assessment events according to the new assessment data segment and one or more trigger conditions of the modified assessment data object; and
periodically aggregating, by the assessment engine of the client data management system, the assessment events into a single aggregate assessment and reporting to the client a current single aggregate assessment.

2. The method of claim 1, wherein at least one assessment data object represents a one-time assessment associated with the product or service.

3. The method of claim 1, wherein at least one assessment data object represents a recurring assessment associated with the product or service.

4. The method of claim 1, wherein at least one assessment data object represents a usage assessment based at least in part on the client using a resource associated with the product or service.

5. The method of claim 1, wherein at least one assessment data object represents an overage assessment based at least in part on the client using a resource associated with the product or service that exceeds a defined maximum during a defined period.

6. The method of claim 1, further comprising updating the processed-through cursor and the assessed-through cursor of each assessment data segment that generated an assessment event.

7. The method of claim 1, wherein the assessments are based at least in part on usage of a defined amount of resources associated with the product or service in a defined period, wherein the plurality of assessment data objects includes a base assessment data object and an overage assessment data object, and wherein the method further comprises:
defining, by the assessment engine, a rolling window of time that includes at least one assessment period; and
defining, by the assessment engine, a base number of the units of measurements allocated to the rolling window and associated with the base assessment data object having a base assessment value;
and wherein generating assessment events comprises:
generating, by the assessment engine, an assessment event corresponding to the base assessment data object; and
if the client uses more units of measurement during the current rolling window than the defined base number of the units of measurement, generating, by the assessment engine, an assessment event corresponding to the overage assessment data object.

8. The method of claim 1, wherein the account comprises a discount assessment data object, and wherein the method further comprises:
determining, by the assessment engine, an open period associated with the discount assessment data object; and
determining, by the assessment engine, a discount balance associated with the discount assessment data object;
wherein the discount balance is applied to at least one assessment event generated during the open period.

9. The method of claim 8, wherein after the discount balance is applied to at least one assessment event of a current period, a remaining discount balance is available to be applied to at least one assessment event generated in a subsequent period.

10. At least one processor readable storage medium storing a computer program of instructions configured to be readable by at least one computer processor for instructing the at least one computer processor to execute a computer process for performing the method as recited in claim 1.

11. A client data management system for managing data for a plurality of users in a computer network, wherein each user has a plurality of clients, wherein each client of each user has a respective associated account maintained by the client data management system, the client data management system comprising one or more computers and one or more storage devices storing instructions that are operable, when executed by the one or more computers, to cause the one or more computers to perform operations comprising:
providing a user interface that is communicatively coupled to and configured to operate in the client data management system to provide user access to a client data manager and an assessment engine executing on the client data management system;
receiving, via the user interface from each user of the plurality of users, a plurality of plan definitions, each plan definition identifying a respective product or service associated with a respective user and defining corresponding plan information
generating, by the client data manager, responsive to receiving a plan definition of a product or service of a particular user, a plurality of different time-independent assessment data objects for the plan definition, wherein each assessment data object comprises attributes including at least a trigger condition, a unit of measurement, and a cost per unit of measurement;
generating, by the client data manager, responsive to the generation of the plurality of different time-independent assessment data objects, a respective assessment data segment associated with each of the plurality of assessment data objects, wherein each assessment data segment defines an interval of time over which the associated assessment data object will be applied,
wherein each assessment data segment maintains a respective assess-through cursor and a processed-through cursor, wherein the assessed-through cursor represents how far into the future assessments for the corresponding assessment data object are defined, and wherein the processed-through cursor represents how many assessment periods have already generated assessment events for the corresponding assessment data object;
generating, by the assessment engine, assessment events according to assessment data segments and trigger conditions of the plurality of assessment data objects of the plan definition and after generating each assessment event for an assessment data segment, updating the processed through cursor of the assessment data segment;
before the processed-through cursor reaches the assessed-through cursor of an assessment data segment for a particular original assessment data object of the plan definition, receiving a change to the original assessment data object;
in response to receiving the change to the original assessment data object, generating a modified version of the original assessment data object for the plan and adding a new assessment data segment for the modified assessment data object, wherein the new assessment data segment covers a time period subsequent to assessment events generated from the original assessment data segment of the original assessment data object;
generating, by the assessment engine of the client data management system, additional assessment events according to the new assessment data segment and trigger conditions of the modified assessment data object; and
periodically aggregating the assessment events into a single aggregate assessment and reporting to the client a current single aggregate assessment.

12. The system of claim 11, wherein at least one assessment data object represents a one-time assessment associated with the product or service.

13. The system of claim 11, wherein at least one assessment data object represents a recurring assessment associated with the product or service.

14. The system of claim 11, wherein at least one assessment data object represents a usage assessment based at least in part on the client using a resource associated with the product or service.

15. The system of claim 11, wherein at least one assessment data object represents an overage assessment based at least in part on the client using a resource associated with the product or service that exceeds a defined maximum during a defined period.

16. The system of claim 11, wherein the operations further comprise updating the processed-through cursor and the assessed-through cursor of each assessment data segment that generated an assessment event.

17. The system of claim 11, wherein the assessments are based at least in part on usage of a defined amount of resources associated with the product or service in a defined period, wherein the plurality of assessment data objects includes a base assessment data object and an overage assessment data object, and wherein the operations further comprise:
defining a rolling window of time that includes at least one assessment period; and
defining a base number of the units of measurements allocated to the rolling window and associated with the base assessment data object having a base assessment value;
generating an assessment event corresponding to the base assessment data object; and
if the client uses more units of measurement during the current rolling window than the defined base number of the units of measurement, generating an assessment event corresponding to the overage assessment data object.

18. The system of claim 11, wherein the account includes negative, discount assessment data objects, and wherein the operations further comprise:
determining an open period associated with the discount assessment data object; and
determining a discount balance associated with the discount assessment data object;
wherein the discount balance is applied to at least one assessment event generated during the open period.

19. The system of claim 18, wherein after the discount balance is applied to at least one assessment event of a current period, a remaining discount balance is available to be applied to at least one assessment event generated in a subsequent period.

20. (canceled)

21. One or more non-transitory computer storage media encoded with computer program instructions that when executed by one or more computers cause the one or more computers to implement a client data management system for managing data for a plurality of users in a computer network, wherein each user has a plurality of clients, wherein each client of each user has a respective associated account maintained by the client data management system, and wherein the instructions when executed by the one or more computers cause the client data management system to perform operations comprising:
providing a user interface that is communicatively coupled to and configured to operate in the client data management system to provide user access to a client data manager and an assessment engine executing on the client data management system;
receiving, via the user interface from each user of the plurality of users, a plurality of plan definitions, each plan definition identifying a respective product or service associated with a respective user and defining corresponding plan information;
generating, by the client data manager, responsive to receiving a plan definition of a product or service of a particular user, a plurality of different time-independent assessment data objects for the plan definition, wherein each assessment data object comprises attributes including at least a trigger condition, a unit of measurement, and a cost per unit of measurement;
generating, by the client data manager, responsive to the generation of the plurality of different time-independent assessment data objects, a respective assessment data segment associated with each of the plurality of assessment data objects, wherein each assessment data segment defines an interval of time over which the associated assessment data object will be applied,
wherein each assessment data segment maintains a respective assessed-through cursor and a processed-through cursor, wherein the assessed-through cursor represents how far into the future assessments for the corresponding assessment data object are defined, and wherein the processed-through cursor represents how many assessment periods have already generated assessment events for the corresponding assessment data object;
generating, by the assessment engine, assessment events according to assessment data segments and one or more trigger conditions of the plurality of assessment data objects of the plan definition and after generating each assessment event for an assessment data segment, updating the processed-through cursor of the assessment data segment;
before the processed-through cursor reaches the assessed-through cursor of an assessment data segment for a particular original assessment data object of the plan definition, receiving a change to the original assessment data object;
in response to receiving the change to the original assessment data object, generating a modified version of the original assessment data object for the plan and adding a new assessment data segment for the modified assessment data object, wherein the new assessment data segment covers a time period subsequent to assessment events generated from the original assessment data segment of the original assessment data object;
generating, by the assessment engine of the client data management system, additional assessment events according to the new assessment data segment and one or more trigger conditions of the modified assessment data object; and
periodically aggregating the assessment events into a single aggregate assessment and reporting to the client a current single aggregate assessment.
